(19) United States
(12) Patent Application Publication
(10) Pub. No.: US 2026/0210253 A1
(43) Pub. Date: Jul. 23, 2026

(54) STATOR PART WITH BLADE AND FIN ARRANGEMENT IN A TURBOMACHINE

(71) Applicant: SAFRAN, PARIS (FR)

(72) Inventors: William Henri Joseph RIERA, MOISSY-CRAMAYEL (FR); Simon Pierre Michel MARTIN, MOISSY-CRAMAYEL (FR)

(73) Assignee: SAFRAN, PARIS (FR)

(21) Appl. No.: 19/136,137

(22) PCT Filed: Dec. 5, 2023
(86) PCT No.: PCT/FR2023/051934

§ 371 Date: Jun. 5, 2025

(30) Foreign Application Priority Data
Dec. 6, 2022 (FR) FR2212824

(51) Int. Cl. F01D 5/14; F01D 9/04

(52) U.S. Cl. CPC F01D 5/145; F01D 9/041; F05D 2220/323; F05D 2240/12

(57) ABSTRACT

The invention relates to a stator part (20) comprising a platform (22), a blade (24, 26) that has a maximum camber (526), a fin (28) extending from a root (44) to a head (46), the head (46) extending from a leading edge (31) to a trailing edge (37), the fin (28) and the blade (24, 26) being arranged such that: —the maximum camber (526) lies between the leading edge (31) and the trailing edge (37); —a ratio of a distance between the maximum camber (526) and the leading edge (31) to a fin chord length (54) is between 5% and 95%; and—the fin head defines a recess (45) extending on either side of the maximum camber (526) over a recess length (47) that is less than or equal to 20% of the chord length (54).

### FIELD OF THE INVENTION

The invention relates to the stator parts of a turbomachine comprising a blade, such as flow rectifiers, located downstream of a compressor, and in particular rectifiers with fixed pitch.

### PRIOR ART

In an aircraft turbomachine, and in particular in passenger aircraft, the air propelled by a fan and the combustion gases leaving the turbomachine through an exhaust nozzle exert reaction thrust on the turbomachine and, through it, on the aircraft. The flow of gases through the turbomachine is influenced by rotating blades and fixed vanes. Fixed or stator vanes include outlet guide vanes (also known as OGVs), inlet guide vanes (also known as IGVs), and vanes with variable pitch (also known as variable stator vanes or VSVs). The rectifier vanes of a gas turbine aircraft engine may each have two platforms (inner and outer) which are attached on the vanes. There are also open fan architectures comprising rectifier vanes with a single inner platform. In all cases, these rectifier vanes form rows of fixed vanes that guide the gas flow through the engine at an appropriate speed and angle.

Within a rectifier comprising a plurality of fixed blades, the flow of gases generally takes place between the blades in an upstream-to-downstream direction.

However, it is known that secondary aerodynamic flows can occur in the areas of the blade root and tip.

For each pair of blades facing each other, a pressure gradient between the pressure side (intrados) of the first blade and the suction side (extrados) of the second blade generates a cross-flow which transports the gases to the extrados.

At the blade tip, i.e. at the junction between the vanes and the hub or between the vanes and the casing, a corner separation and a corner vortex can occur. This separation generates pressure losses and aerodynamic blockage. The latter is problematic in terms of operability.

A fin can be placed on the hub or casing between two blades facing each other so as to reduce the cross-flow. The fins can improve the operability of the compressor stators by limiting the cross-flow between the vanes.

The geometry of a grid of vanes, i.e. a set of vanes distributed circularly around an axis, can be optimised for high-speed fluid flows, and in particular transonic flows close to the speed of sound. The addition of a fin in such an optimised grid can greatly degrade the operation of these optimised vanes.

There is therefore a need for a new geometry to correct these problems and improve performance in terms of equipment efficiency, particularly for transonic fluid flows.

### DISCLOSURE OF THE INVENTION

One aim of the invention is to provide a novel vane geometry that will improve the performance of the equipment in terms of efficiency, in particular for transonic flows.

The aim is achieved within the context of the present invention by means of a stator part of a turbomachine comprising:
a platform defining a wall of a gas flow duct,
a blade extending radially with respect to an axis of the turbomachine from the platform, the blade having a camber maximum, and
a fin extending radially in the duct from a root located on the platform to a tip, the tip extending axially along the axis from a leading edge to a trailing edge and having a chord length connecting, in a straight line, the leading edge and the trailing edge,
the fin and the blade being designed such that:
the camber maximum is located axially between the leading edge and the trailing edge,
a ratio of a distance measured axially between the camber maximum and the leading edge to the chord length is less than or equal to 95% and greater than or equal to 5%, and
a fin height defined between the root and the tip varies along the axis so as to define a recess in the fin, the recess extending axially from one side to the other of the camber maximum over a recess length less than or equal to 20% of the chord length.

Such a part is advantageously and optionally supplemented by the various following features, taken alone or in combination:
the fin height has a maximum height, and a minimum height in the recess, a ratio of the minimum height over the maximum height being less than or equal to 20%;
the ratio of the minimum height over the maximum height is less than or equal to 10% and preferably equal to 5%;
the fin height in the recess is symmetric with respect to an axial position of the camber maximum; and
the fin height in the recess as a function of a coordinate along the axis has a first rate of variation upstream of an axial position of the camber maximum and a second rate of variation downstream of the axial position, the terms “upstream” and “downstream” referring to a main flow direction of the gases in the stator part, the first rate of variation being greater in absolute value than the second rate of variation.

The invention also relates to a turbomachine comprising a stator part such as described above and to an aircraft comprising such a turbomachine.

### DESCRIPTION OF THE FIGURES

Other features and advantages of the invention will emerge from the following description, which is given purely by way of illustration and not being limiting and which should be read with reference to the attached drawings, in which:

FIG. 1 is a schematic representation of a turbomachine;

FIG. 2, FIG. 3 and FIG. 4 are schematic views of a stator part according to various embodiments.

### DETAILED DESCRIPTION OF THE INVENTION

### Turbomachine

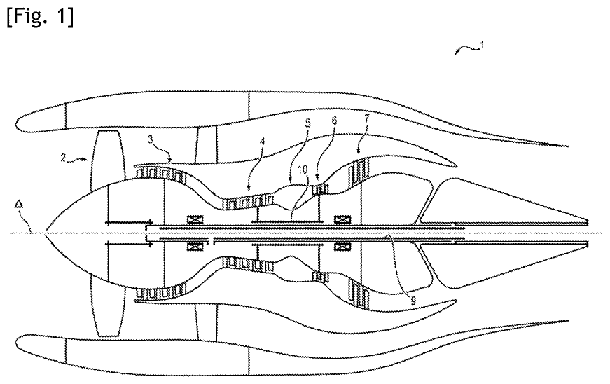

FIG. 1 shows a schematic representation of a turbomachine, more specifically an axial turbofan engine 1. Other types of turbomachine can be improved by the teaching presented here and in particular open fan turbomachines. The turbojet 1 illustrated extends along an axis Δ and comprises, in succession in the main flow direction of the gases in the turbomachine, a fan 2, a compression section which may comprise a low-pressure compressor 3 and a high-pressure compressor 4, a combustion chamber 5, and a turbine section which may comprise a high-pressure turbine 6, a low-pressure turbine 7 and an exhaust nozzle.

The fan 2 and the low-pressure compressor 3 are driven in rotation by the low-pressure turbine 7 via a first transmission shaft 9, while the high-pressure compressor 4 is driven in rotation by the high-pressure turbine 6 via a second transmission shaft 10.

In operation, a flow of air compressed by the low-pressure and high-pressure compressors 3, 4 feeds a combustion in the combustion chamber 5, the expansion of the combustion gases of which drives the high-pressure and low-pressure turbines 6, 7. The air propelled by the fan 2 and the combustion gases leaving the turbojet 1 through an exhaust nozzle downstream of the turbines 6, 7 exert a reaction thrust on the turbojet 1 and, through it, on a vehicle or craft such as an aircraft (not illustrated).

### Stator Part

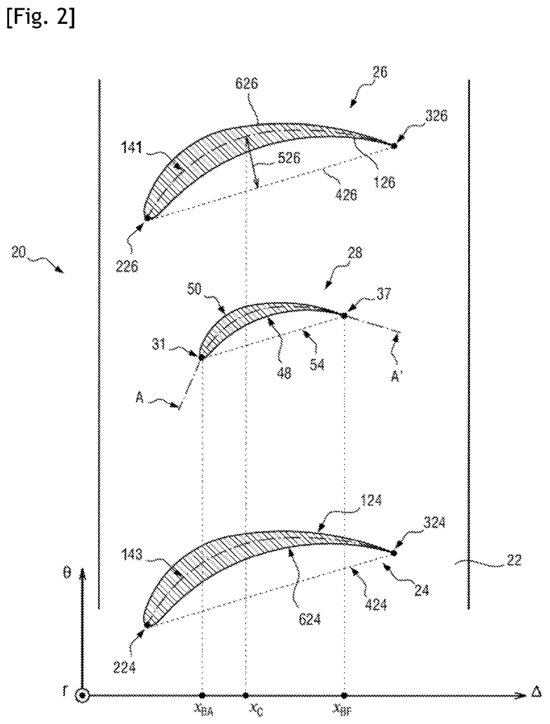

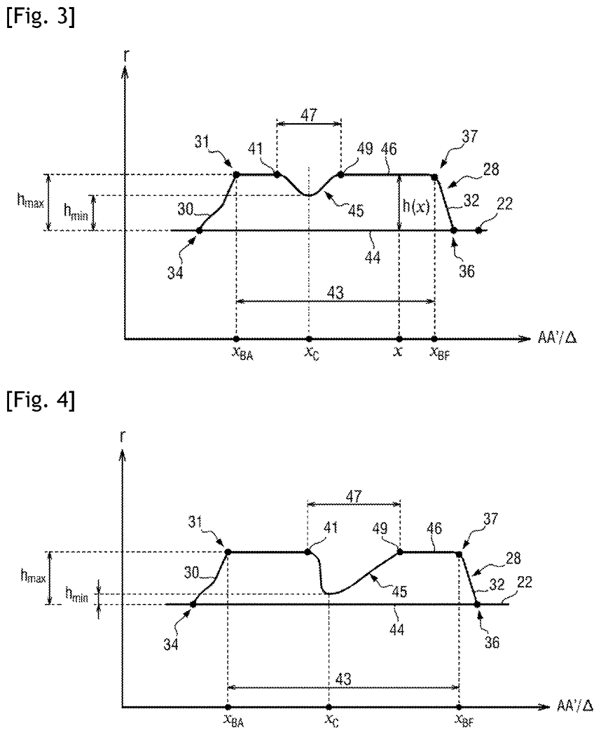

Downstream of the fan or a compression stage, the turbomachine may comprise a flow-straightening vane stage. Such a flow-straightening vane stage may comprise a stator part 20 as shown with reference to FIG. 2.

The stator part may be one of the stators included in one of the low-pressure or high-pressure axial compressors. The stator part may also comprise a grid of outlet guide vanes, as in the secondary rectifier on the fan module.

The stator part 20, or stator part assembly 20 if it is not in one piece, has at least one blade 24, 26 and a platform 22 from which the blade 24, 26 extends,

For example, the stator part may comprise two adjacent blades 24, 26 extending from the platform 22.

The term “platform” refers here to any component of the turbomachine on which the blades 24, 26 are able to be mounted. In particular, the platform may be a hub or a casing that surrounds the axis of the turbomachine. The platform can also be sectorised, i.e. it comprises an assembly of parts distributed angularly around the axis in ideally equal angular sectors. The platform may have a cylindrical surface at a constant radial distance from the axis Δ of the turbomachine. The platform 22 has an inner wall or alternatively an outer wall against which the air flows, i.e. the platform 22 defines a wall of a gas flow duct. The blades 24, 26 extend from the platform 22 into the stream either radially outwards away from the turbomachine axis Δ or radially inwards towards the turbomachine axis Δ.

In FIG. 2, the axis Δ of the turbomachine is shown positively oriented in the direction of the main gas flow in the turbomachine. FIG. 2 also shows a radial axis r perpendicular to the axis Δ of the turbomachine and which passes through the axis Δ of the turbomachine. The radial axis is positively oriented in the direction away from the axis Δ of the turbomachine. FIG. 2 also shows a circumferential axis θ that is perpendicular to the radial axis r and the axis Δ of the turbomachine.

FIG. 2 is a schematic representation of the stator part 20 along a section in a plane perpendicular to the radial axis r. More specifically, FIG. 2 is a schematic representation of the stator part 20 in a circumferential plane that is at a constant distance from the axis Δ of the turbomachine. Such a circumferential plane parallel to the axis Δ of the turbomachine makes it possible to define a cross-section of the blades 24, 26.

The blades 24 and 26 each have an intrados 624, 126 and an extrados 124, 626.

The blades 24 and 26 each comprise a leading edge 224, 226 on the upstream side and a trailing edge 324, 326 on the downstream side. The terms upstream and downstream are defined in relation to the general flow of gases through the turbomachine, which is from upstream to downstream in the direction and sense of the axis Δ of the turbomachine.

The blades define a blade chord 424, 426 which is the length of the segment connecting the leading edge and the trailing edge in a circumferential plane of constant radius or constant distance from the axis Δ, which circumferential plane can be referred to as the section plane.

Similarly, in a circumferential section plane, each blade has a camber line 143, 141 which is the curve equal to the average between the extrados curve and the intrados curve. More precisely, the camber line is formed by all the points located at equal distance from the extrados and the intrados. The distance from a particular point to the extrados (or intrados) is defined here as the minimum distance between the particular point and a point on the extrados (or intrados).

Each blade has a camber maximum 526 which corresponds to the maximum distance separating the camber line 141, 143 and the chord 424, 426. More precisely, the maximum distance corresponds to the maximum of the distances measured perpendicular to the chord between a point on the camber line and the corresponding point on the chord as the chord is traversed. The axial coordinate x_{C}—i.e. the coordinate along the A axis of the turbomachine—of the camber maximum corresponds to the axial position of the point on the camber line for which the distance to the chord is maximum.

### Fin

The stator part 20 also comprises a fin 28 which extends from the platform 22 in the same direction and the same direction of extension as the blades 24, 26. The fin 28 extends radially in the duct with respect to the axis Δ of the turbomachine from the platform 22.

The fin 28 has an extrados 50 which faces the intrados 126 of the blade 26.

When the part comprises two blades 24, 26 facing each other, the fin 28 is located between the blades 24 and 26. More specifically, the fin 28 is located opposite the extrados 124 of the first blade 24 and opposite the intrados 126 of the second blade 26.

The fin 28 comprises an intrados 48 facing the extrados 124 of the first blade and an extrados 50 facing the intrados 126 of the second blade 26.

The fin extends radially into the duct from a fin root 44 located on the platform 22 to a fin tip 46.

The fin 28 can be modelled or represented as a stack of profiles, i.e. section surfaces, in a radial direction between a fin root 44 corresponding to a first profile of the fin and a fin tip 46 corresponding to a last profile of the fin. The fin root 44 is located on the platform 22 and corresponds to the intersection of the fin 28 and the platform 22. The fin tip is located at a distance from the platform 22 in the gas flow duct. Each fin profile extends in a circumferential plane parallel to the axis Δ of the turbomachine, as a section of the fin made in this circumferential plane at constant radius or constant distance from the axis Δ, a circumferential plane that can be referred to as a section plane.

Each fin profile defines a fin chord between the leading edge 30 of the fin and the trailing edge 32 of the fin. More precisely, the fin chord is defined between a first point at the intersection of the leading edge 30 and the section plane and a second point at the intersection of the trailing edge 32 and the section plane. The fin chord designates the length of the segment connecting the first point and the second point. The chord line designates the segment connecting the first and second points.

FIG. 2 shows the fin 28 in cross-section at the fin tip which extends axially from a leading point 31 of the leading edge 30 to a trailing point 37 of the trailing edge 32. The fin tip defines a chord length 54 joining the leading point 31 and the trailing point 37 in a straight line. When the fin tip is projected onto the Δ axis of the turbomachine, a projection segment is obtained, the two ends of which are the projection x_{BA} of the leading edge 31 and the projection x_{BF} of the trailing edge 37. These projections correspond to axial coordinates x_{BA} and x_{BF}—in other words coordinates along the axis Δ of the turbomachine. These projections can be used to define the projected tip chord 43 on the Δ axis of the turbomachine, which is |x_{BA}−x_{BF}| and which is less than or equal to chord length 54 of the fin tip.

The fin tip has a camber line between points A and A′ which is the curve equal to the average between the curve of the extrados 50 and the curve of the intrados 48 in the section plane.

FIGS. 3 and 4 correspond to a cross-section of the fin along a meridian plane which corresponds to the axial directions r which pass through the points of curve AA′ in the section plane of FIG. 2 as this camber line is traversed. The abscissa axis in FIGS. 3 and 4 corresponds to a curvilinear abscissa along curve AA′ to which an axial coordinate may also correspond by projection onto the axis Δ of the turbomachine. In FIGS. 3 and 4, the ordinate axis corresponds to the radial direction r and corresponds to a distance from the axis Δ of the turbomachine.

The leading edge 30 comprises a leading point 34 located on the platform 22. The leading point 34 corresponds to the intersection of the leading edge 30 and the platform 22.

The trailing edge 32 includes a trailing point 36 located on the platform 22. The trailing point 36 corresponds to the intersection of the trailing edge 32 and the platform 22.

The shape of the leading edge 30 and the trailing edge 32 is not important here. These edges can be steep, i.e. oriented in a radial direction, or oblique, i.e. oriented in a direction that makes a non-zero angle with the radial direction. The leading edge 30 and the trailing edge 32 can have any shape, depending on the stacking law of the profiles that make up the fin 28.

The fin 28 and the blade 24 and/or 26 are arranged so that the camber maximum 526 is located axially between the leading edge 31 and the trailing edge 37. In other words, when the camber maximum and the fin tip profile are projected onto the Δ axis of the turbomachine, the projection of the camber maximum lies within the projection segment between the two ends of the projection of the fin tip profile which correspond to the projections of the leading edge 31 and the trailing edge 37. In other words, the axial coordinate x_{C} is between the axial coordinates x_{BA} and x_{BF}. In other words, with respect to the main flow of gases in the turbomachine, the camber maximum is located downstream of the leading edge 31 of the fin tip 46 and upstream of the trailing edge 37 of the fin tip 46.

Moreover, a ratio of an axially measured distance between the camber maximum 526 and the leading edge 31 of the fin tip 46 to the projected chord length 43 of the fin tip 46 is less than or equal to 95% and greater than or equal to 5%. This means that by calculating the ratio between the distance separating the projection on the Δ axis of the camber maximum 526 and the projection on the Δ axis of the leading edge 31 on the projection on the axis of the chord 54 of the fin tip 46, a ratio of between 5% and 95% is obtained. This condition can also be written using the axial coordinates x_{C}, x_{BA} and x_{BF} in the form:

$$0.95 \geq \vert {x}_{BA} - {x}_{C} \vert / \vert {x}_{BA} - {x}_{BF} \vert \geq 0. 05$$

This condition is equivalent to the following condition: an axially measured distance between the camber maximum 526 and the trailing edge 37 of the fin tip 46 over the projected chord length 43 of the fin tip 46 is less than or equal to 95% and greater than or equal to 5%. This means that by calculating the ratio between the distance separating the projection on the Δ axis of the camber maximum 526 and the projection on the Δ axis of the trailing edge 37 on the projection on the axis of the chord 54 of the fin tip 46, a ratio of between 5% and 95% is obtained. This condition can also be written using the axial coordinates x_{C}, x_{BA} and x_{BF} in the form:

$$0.95 \geq \vert {x}_{BF} - {x}_{C} \vert / \vert {x}_{BA} - {x}_{BF} \vert \geq 0.05 .$$

### Fin Height

The fin 28 extends radially from the root profile 44 to the tip profile 46 over a fin height h(x).

It should be noted that this height is defined in relation to a platform 22 considered to be at a constant distance from the axis of the turbomachine.

The fin height h(x) varies as a function of the axial coordinate x, in other words along the axis Δ. The height h(x) is illustrated schematically in FIG. 3. More precisely, h(x) is the fin height along the camber line AA′.

In particular, the height h(x) as a function of the axial coordinate x has a local minimum, the local minimum being located axially close to the axial coordinate x_{C} of the camber maximum 526.

In other words, the fin has a recess 45 which extends axially on either side of the camber maximum 526.

The recess has a recess length 47 defined along the axis Δ.

This recess length 47 can, for example, be defined between:
an upstream point 41 on the fin tip 46 located upstream of the recess, i.e. between the recess 45 and the leading edge 31 of the tip 46, and
a downstream point 49 of the fin tip 46 located downstream of the recess, i.e. between the recess 45 and the trailing edge 37 of the tip 46.

The upstream point 41 may correspond, for example, to the first point on the camber line of the fin tip 46 at which the height of the fin decreases as the fin is traversed from upstream to downstream.

The downstream point 49 may correspond, for example, to the first point on the camber line of the fin tip 46 located downstream of the camber maximum 526, for which, when the fin is traversed from upstream to downstream, the height of the fin remains constant or reaches the value of the height of the fin at the upstream point 41.

The length of the recess 47 is chosen to be less than or equal to 20% of the length of the chord 54.

Preferably, the length of the recess 47 can also be chosen to be less than or equal to 15% or 10% of the length of the chord 54.

Preferably, the length of the recess 47 can also be chosen to be greater than or equal to 2% of the length of the chord 54.

The presence of a recess in the fin limits the aerodynamic obstruction effects encountered on the stators at high speed, particularly in the transonic regime, while maintaining a blockage in the cross-flow.

In the transonic regime, part of the flow has a flow velocity greater than the speed of sound and part of the flow has a flow velocity less than the speed of sound.

Areas where the velocity decreases from above the speed of sound to below the speed of sound correspond to a shock. This is particularly the case when the flow cross-section increases, which is accompanied by a reduction in flow velocity. In these zones there is a very sharp reduction in speed and a very sharp variation in pressure, which can be very highly localised spatially, corresponding to the shock. These shocks can lead to a detachment of the hub boundary layer but also on the extrados of the vanes involved in an inter-blade channel. This shock is the opposite of the main effect that we expect from a fin, which is to limit corner detachments by acting on the cross-flow.

In a grid of stators intended for use in transonic regimes, these zones are located inside the grid and their positions depend, in particular, on the inclination and thickness of the vanes. However, this position is correctly approximated by the axial coordinate of the camber maximum of the vanes.

By being axially located at this camber maximum of the vanes, the recess has an axial position which corresponds to that of the shock associated with the aerodynamic obstruction. The recess thus positioned therefore corresponds to a removal of material from an area of the flow duct where the shock associated with the aerodynamic obstruction occurs. If this material were retained, it could produce a shock or worsen the effects of a shock. Its removal limits the effects of aerodynamic obstruction.

The advantages of this fin shape, compared with the non-recessed shape, are as follows:
at high incidence (e.g. at partial speed), the fin retains its main effect of blocking the cross-flow and therefore reduces the secondary flows at the stator root: the operability of the compressor is improved, and
in adjusted operation (e.g. at the cruising point), the recess limits the effect of the fin on shock-related blocking and therefore limits losses: the maximum efficiency of the compressor is increased.

The cross-flow over the rectifiers is then effective at low speed (subsonic) but also at high speed (transonic).

As an option for the minimum fin height, the fin height has a maximum height hₘₐₓ, and a minimum height hₘᵢₙ in the recess 45, a ratio of the minimum height over the maximum height being less than or equal to 20%.

In particular, the maximum height can be reached upstream of recess 45 and downstream of recess 45. For example, the fin height is equal to the maximum height on the camber line at the fin tip 46 between the leading point 31 and the upstream point 41, then between the downstream point 49 and the trailing point 37.

The minimum height hₘᵢₙ in the recess 45 corresponds to the local height minimum in the area of the recess. In particular, this minimum height can be obtained for the axial coordinate x_{C} of the camber maximum 526, i.e. h(x_{C})=hₘᵢₙ.

The ratio of the minimum height hₘᵢₙ over the maximum height hₘₐₓ is chosen to be less than or equal to 20%, i.e. (hₘᵢₙ/h max)≤0.2.

More advantageously, the ratio of the minimum height hₘᵢₙ over the maximum height hₘₐₓ can be chosen to be less than or equal to 5%, i.e. (hₘᵢₙ/hₘₐₓ)≤0.05.

Thus, these limited minimum heights are sufficient to maintain the blocking effect, in the lower part of the boundary layer, at partial speed in the event of the stator being subjected to a high-incidence fluid.

According to a first embodiment, the fin height in the recess is symmetric with respect to an axial position of the camber maximum. For example, the curve h(x) of the fin height along the camber line AA′ is symmetrical at the recess. This means that, on the one hand, the decrease in fin height from the upstream point 41 downstreamwards and to the minimum height and, on the other hand, the increase in fin height from the minimum height downstreamwards and to the downstream point 49, mirror each other. The minimum height is then placed in the middle between the upstream point 41 and the downstream point 49. This symmetry can be evaluated, in particular, along the camber line or by projecting this camber line axially. Preferably the symmetry is evaluated along the camber line. This first method is shown in FIG. 3.

According to a second embodiment, the fin height in the recess is symmetric with respect to an axial position of the camber maximum. In particular, the fin height in the recess as a function of a coordinate along the axis Δ of the turbomachine has a first rate of variation upstream of an axial position of the camber maximum, and a second rate of variation downstream of the axial position, the first rate of variation being greater in absolute value than the second rate of variation. This means that, firstly, the decrease in fin height from the upstream point 41 downstreamwards and to the minimum height occurs at a higher rate of variation than the increase in fin height from the minimum height downstreamwards and to the downstream point 49. The minimum height is then placed closer to the upstream point 41 than to the downstream point 49. This second mode is shown in FIG. 4.

Thus, when the fin is traversed in the direction of the chord from upstream to downstream, the recess begins with a rapid decrease in height followed by a slower increase in height. This difference allows the flow to be guided for longer at the fin peak, and potentially improves the wall effect against the cross-flow.

1. A stator part for a turbomachine comprising:
a platform defining a wall of a gas flow duct,
a blade extending radially with respect to an axis of the turbomachine from the platform, the blade having a camber maximum, and
a fin extending radially in the duct from a root to a tip, the root being located on the platform, the tip extending axially along the axis from a leading edge to a trailing edge, the tip having a chord length, the chord length connecting, in a straight line, the leading edge and the trailing edge,
the fin and the blade being designed such that:
the camber maximum is axially located between the leading edge and the trailing edge,
a ratio of an axially measured distance between the camber maximum and the leading edge over the chord length is less than or equal to 95% and greater than or equal to 5%, and
a fin height defined between the root and the tip varies along the axis so as to define a recess in the fin, the recess extending axially over a recess length, the recess length being less than or equal to 20% of the chord length, a projection of the camber maximum along the axis lies within a projection of the recess along the axis.

2. The stator part according to claim 1, wherein the fin height has a maximum height, and a minimum height in the recess, a ratio of the minimum height over the maximum height being less than or equal to 20%.

3. The stator part according to claim 2, wherein the ratio of the minimum height over the maximum height is less than or equal to 10% and preferably equal to 5%.

4. The stator part according to claim 1, wherein the fin height as a function of a coordinate along the axis is symmetric in the recess with respect to an axial position of the camber maximum.

5. The stator part according to claim 1, wherein the fin height in the recess as a function of a coordinate along the axis has a first rate of variation upstream of an axial position of the camber maximum and a second rate of variation downstream of the axial position, the terms upstream and downstream referring to a main flow direction of the gases in the stator part, the first rate of variation being greater in absolute value than the second rate of variation.

6. A turbomachine comprising a stator part according to claim 1.

7. An aircraft comprising a turbomachine according to claim 6.
